(19) United States
(12) Patent Application Publication
(10) Pub. No.: US 2025/0076813 A1
(43) Pub. Date: Mar. 6, 2025

(54) WATCH

(71) Applicant: CASIO COMPUTER CO., LTD., Tokyo (JP)

(72) Inventors: Iichiro HASHIMOTO, Tokyo (JP); Keishiro YAMAMOTO, Tokyo (JP)

(73) Assignee: CASIO COMPUTER CO., LTD., Tokyo (JP)

(21) Appl. No.: 18/819,321

(22) Filed: Aug. 29, 2024

(30) Foreign Application Priority Data
Aug. 31, 2023 (JP) 2023-140622

(51) Int. Cl. G04B 19/22; G04B 19/23

(52) U.S. Cl. CPC G04B 19/223; G04B 19/23

(57) ABSTRACT

Provided is a watch including a dial, a first pointer, and a second pointer. A plurality of hour markers and a plurality of markers other than the plurality of hour markers are mounted on the watch. The first pointer points at one of the plurality of hour markers on the dial by rotating around a first rotation axis. The second pointer points at one of the plurality of markers on the dial by rotating around a second rotation axis. Numerals or letters respectively corresponding to the plurality of markers are placed on respective extension lines of the plurality of markers adjacent to one another.

### CROSS-REFERENCE TO RELATED APPLICATIONS

This application is based upon and claims the benefit of priority from the prior Japanese Patent Application No. 2023-140622 filed on Aug. 31, 2023, the entire contents of which are incorporated herein by reference.

### TECHNICAL FIELD

The present invention relates to a watch.

### DESCRIPTION OF RELATED ART

Conventionally, there has been a watch with a power reserve indication mechanism in which a scale (M) is displayed on a dial (face) and the scale M labelled with numerals on extension lines of markers which are at predetermined intervals and are pointed at by an indication hand (78), as disclosed in JP2006-234432A, for example.

### SUMMARY OF THE INVENTION

According to an aspect of the present invention, there is provided a watch including:
a dial on which a plurality of hour markers and a plurality of markers other than the plurality of hour markers are mounted;
a first pointer that points at one of the plurality of hour markers on the dial by rotating around a first rotation axis; and
a second pointer that points at one of the plurality of markers on the dial by rotating around a second rotation axis,
wherein numerals or letters respectively corresponding to the plurality of markers are placed on respective extension lines of the plurality of markers adjacent to one another,
wherein the letters include a set of letters.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a plan view of a watch according to the present invention;

FIG. 2 is an enlarged view of an altitude indicator part corresponding to part II of FIG. 1;

FIG. 3A shows how a pointer points at an altitude marker in the altitude indicator part;

FIG. 3B shows how a pointer points at an altitude marker in the altitude indicator part; and

FIG. 4 shows the altitude indicator part with numerals or letters on extensions of all markers.

### DETAILED DESCRIPTION

Hereinafter described are embodiments of the present invention with reference to the drawings. However, various limitations that are technically preferable to execute the present disclosure are described in the embodiments below. Therefore, the technical scope of the present disclosure is not limited to the embodiments described below and the illustrated examples.

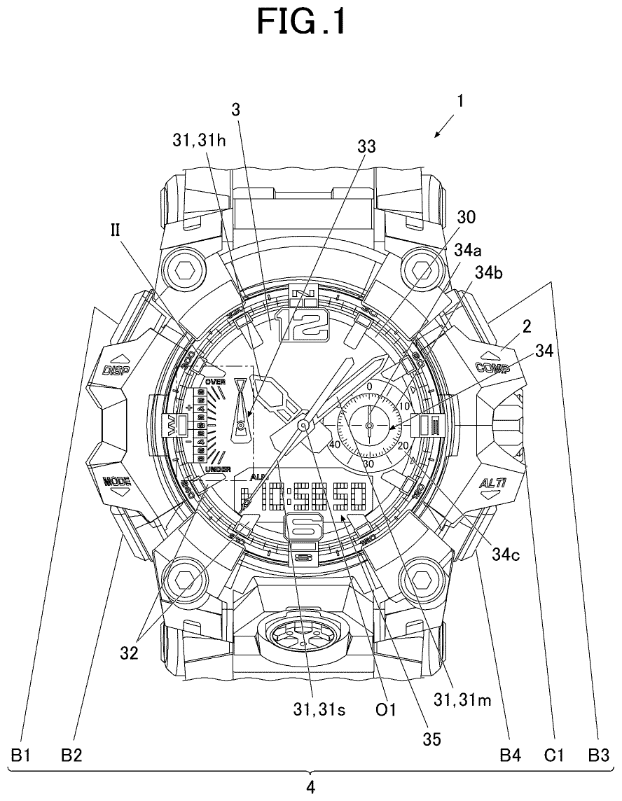

FIG. 1 is a plan view of a watch 1.

The watch 1 is, for example, a wristwatch. The watch 1 is provided with a casing 2, a display part 3 including a dial 30 and pointers 31 (first pointer), an operation receiver 4 including pushbuttons B1, B2, B3, and B4, a crown C1, and the like. The display part 3 is in the casing 2 and covered with a windshield glass (not shown in the drawings). A baseboard (not shown in the drawings), a motor and gears that rotate the pointers 31 (a second hand 31s, a minute hand 31m, and an hour hand 31h) are incorporated below the display 3 inside the casing 2 of the watch 1. The bottom of the watch 1 is sealed by a back cover (not shown in the drawings). The “pointers 31” collectively refer to the second hand 31s, the minute hand 31m, and the hour hand 31h.

The dial 30 is circular, and hour markers 32 (index) and graduations are disposed along the circumference of the dial 30. A pointer axis O1 for rotating the pointers 31 is disposed at the center of the dial 30. The pointers 31 indicate the time by rotating around the pointer axis O1 to point to the hour markers 32 or the graduations as appropriate.

An altitude indicator 33, a stopwatch display part 34, and a digital indicator 35 are mounted on the dial 30.

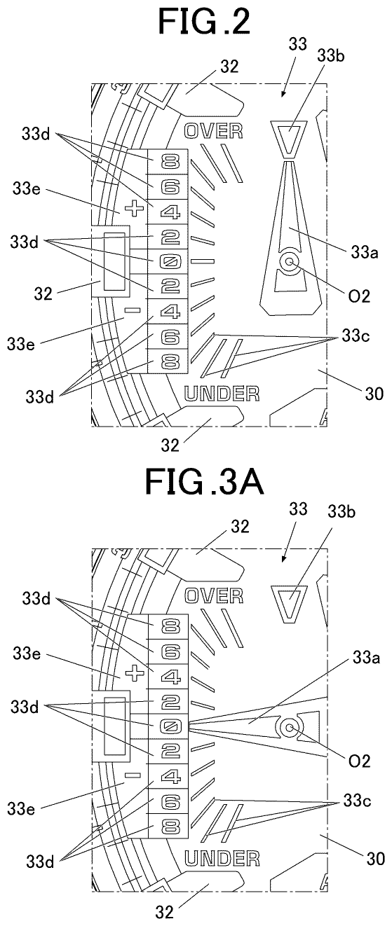

FIG. 2 is an enlarged view of the altitude indicator 33 which is an area enclosed by a dash dot line and indicated by II in FIG. 1. The altitude indicator 33 sets the altitude at the time of activation of an altimeter (not shown in the drawings) inside the casing 2 as 0 (reference altitude), and thereby indicates how much the altitude has changed from there. The altimeter is, for example, a barometric altimeter.

As shown in FIG. 2, the altitude indicator 33 includes a pointer 33a (second pointer), a reference point 33b, markers 33c, numerals 33d corresponding to the markers 33c, and sign display parts 33e. The markers 33c are different from the graduations such as the hour markers 32 which indicate the time. The numerals 33d include letters or words like “OVER,” “UNDER,” and the like, as shown in FIG. 2.

The pointer 33a points at the reference point 33b when the altimeter is not activated. After the altimeter is activated, the pointer 33a rotates around a pointer axis O2 (rotation axis) to point at one of the markers 33c according to the current altitude relative to the altitude at the time of activation which is set as 0.

Here, the user might misread the altitude on a partially numbered scale when the user checks the altitude in a tough situation like in the midst of mountain-climbing. For example, the scale M disclosed in JP2006-234432A is partially numbered (marked with numerals at intervals), and if such a scale is used for the altimeter, the user might misread the altitude when checking the altitude in a tough situation like in the midst of mountain-climbing.

Thus, on the altitude indicator 33 on the watch 1, the adjacent markers 33c respectively have numerals corresponding to the markers 33c placed on their respective extension lines (the lines extended toward the opposite side of the pointer 33a (opposite to axis O2)).

For example, the altitude indicator 33 in FIG. 2 has 13 markers 33c indicating: +2; +4; +6; +8; +10; OVER (more than +10); −2; −4; −6; −8; −10; UNDER (less than −10) centered around one of the markers 33c that indicates 0 (reference marker). Among these markers 33c, the adjacent markers 33c indicating numbers from −8 to +8 are labelled with corresponding numerals 33d “−8” to “+8” on their respective extension lines. Such a display can help the user check the altitude easily, for the markers 33c indicating −8 to +8 are respectively labelled with numerals on the extension lines of the markers 33c, which can reduce the possibility of misreading the altitude.

The hour markers 32 in this embodiment are basically in a rectangular shape, but the hour markers at the 8 o'clock and 10 o'clock positions, for example, have a cut off corner. A space for the altitude indicator 33 can be kept by cutting off part of the hour markers 32, and words such as “OVER” and “UNDER” can be placed on the extension lines of the markers 33c.

Here, the number indicated by graduation of the markers 33c can be set by operating a predetermined pushbuttons of the operation receiver 4 or via the smartphone by the user. The increment of the markers 33c may be set to 2 m of altitude so that the pointer 33a moves from one to another of the markers 33c every 2 m of change in altitude. The increment of the markers 33c may be set to 100 m of altitude so that the pointer 33a moves from one to another of the markers 33c every 100 m of change in altitude.

As a display area of a dial of a watch (wristwatch) is generally limited, it is difficult to label each of adjacent markers with a numeral due to space limitations. However, in the altitude indicator 33 shown in FIG. 2, the adjacent numerals 33d are placed in a single vertical array from top to bottom when the 12 o'clock is top and the 6 o'clock is bottom (i.e., on a line vertical to the extension direction of the reference marker). Therefore, it is possible to place the numerals 33d respectively corresponding to the adjacent markers 33c in a small space on the dial 30.

In the altitude indicator 33, the marker 33c indicating a value 0 which is the reference altitude and its corresponding numeral 33d are placed at such a position that the pointer 33a points at this reference numeral 33d in a horizontal direction, and pairs of the numerals 33d denoting opposite numbers with different signs (“−8” and “8,” “−6” and “6,” “−4” and “4,” and “−2” and “2”) are placed symmetrically with respect to “0” of the numerals 33d. Therefore, the user can intuitively recognize whether and how much the altitude has increased or decreased with respect to the reference.

In the altitude indicator 33, the signs “+” (plus) and “−” (minus) of the numerals 33d are placed collectively at the sign display parts 33e different from the area of the numerals 33d that are supposed to have respective signs. Specifically, the sign display part 33e for “+” associated to the numerals 33d that denote positive numbers and the sign display part 33e for “−” associated to the numerals 33d that denote negative numbers are displayed. It is thereby possible to display numerals with signs in a limited space and make them easily recognized.

The reference numeral 33d denoting 0, the reference altitude, is placed at a position corresponding to the center of the hour marker 32 of the 9 o'clock (or the 3 o'clock in a case where the altitude indicator is positioned on the 3 o'clock side) in the direction of the array of the numerals 33d (the imaginary line connecting 12 o'clock and 6 o'clock). It is thereby possible to keep the area for placing “+” and “−” of the sign display parts 33e. It is also possible for the user to intuitively recognize the plus and minus signs of the numerals 33d. One of the hour markers (the hour marker 32 of 9 o'clock in FIGS. 1 to 4) is placed between the area for placing the sign “+” and the area for placing the sign “−.” It is thereby possible for the user to recognize more easily the plus and minus signs of the numerals 33d.

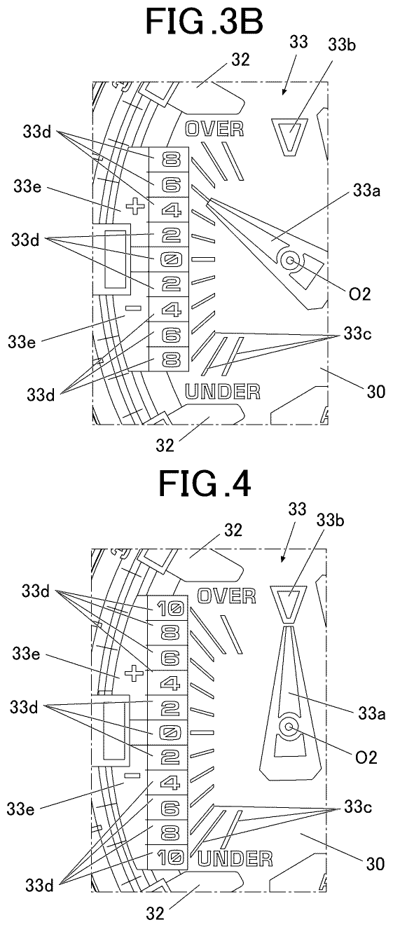

In the altitude indicator 33, when the pointer 33a points at one of the markers 33c, the tip of the pointer 33a overlaps with the one of the markers 33c, as shown in FIGS. 3A and 3C. It is thereby possible for the user to recognize easily which one of the markers 33c is pointed at by the pointer 33a. As shown in FIGS. 3A and 3B, when the pointer 33a points at one of the markers 33c, the pointer 33a does not overlap with the numerals 33d. It is thereby possible to prevent the numerals 33d from being obscured.

In the altitude indicator 33, the line segments of the markers 33c gradually get longer from the reference marker 33c indicating “0” to the markers 33c placed further (outward) from the reference marker 33c.

For example, as shown in FIGS. 3A and 3B, in comparison of the distance between the tip of the pointer 33a and the numeral 33d denoting 0 when the pointer 33a points at the reference marker 33c indicating “0” and the distance between the tip of the pointer 33a and the numeral 33d denoting “6” at the marker 33c indicating “+6,” there is a gap between these distances and the latter one is longer. In a hypothetical case where the marker 33c of “+6” is as long as the marker 33c of “0,” the tip of the pointer 33a pointing to the marker 33c of “+6” does not overlap with the marker 33c when the markers 33c are left-aligned, and the numeral 33d and the marker 33c of “+6” are separated from each other when the markers 33c are right-aligned so that the tip of the pointer 33c overlaps with the markers 33c, which makes it hard to recognize the correspondence between the markers 33c and the numerals 33d. Consequently, in the altitude indicator 33 in which the numerals 33d are placed in a vertical array and the pointer 33c rotates to point at the markers, all the markers 33c can overlap with the tip of the pointer 33a and the correspondence between the numerals 33d and the markers 33c can be recognized easily as the line segments of the markers 33c gradually get longer from the reference marker 33c indicating “O” to the markers 33c placed further (outward) from the reference marker 33c. As the line segments of the markers 33c gradually get longer from the reference marker 33c indicating “0” to the markers 33c placed further (outward) from the reference marker 33c, it is possible for the user to intuitively recognize whether the current altitude is changed from the reference altitude.

The letters of “OVER” and “UNDER” may be colored differently (from the numerals) in the altitude indicator 33. It is thereby possible for the user to recognize the situation where the altitude gets significantly lower or higher. The numerals 33d may be colored differently from one another. It is thereby possible for the user to recognize the altitude easily when it is hard to see the numerals in a tough situation like in the midst of mountain-climbing.

The numerals 33d with the plus sign may be colored differently from the numerals 33d with the minus sign. It is thereby possible for the user to easily recognize whether the altitude is higher or lower than the reference.

In FIGS. 2, 3A, and 3B, the adjacent markers 33c indicating −8 to +8 are labelled with corresponding numerals 33d “−8” to “+8” on their respective extension lines. However, all the markers may be labelled with corresponding numerals 33d (in FIG. 4, “−10” to “+10,” “OVER,” and “UNDER”) on their respective extension lines, as shown in FIG. 4.

Back in FIG. 1, the stopwatch display part 34, which has a pointer 34a, markers 34b, and numerals 34c corresponding to the markers 34b, and displays the measured amount of time that elapses from its activation.

The digital indicator 35 consists of a display such as a liquid crystal display and organic electroluminescent (EL) display. The digital indicator 35 displays the current time and the like, for example.

A circuit board in the casing 2 is a board-shaped member that is constituted by a large-scale integration (LSI), and contains various electronic components for the watch 1 to perform various operations. The circuit board has an electronic circuit (including electrodes) that connects these electronic components. A controller such as a microcontroller, a memory (flash memory, etc.) storing programs and the like, a large capacitor, sensors such as an altimeter, an electronic circuit (oscillator circuit, divider circuit, drive circuit), a crystal oscillator, and the like are mounted on the circuit board. In the watch 1, oscillation is generated by the crystal oscillator, and generated oscillation is divided by the divider circuit and converted into electrical signals at a frequency of one per second. The electrical signals are transmitted to the motor by the drive circuit to move the gears and thereby rotate the pointer 31. That is how the time is displayed on the watch 1. The controller counts the time (which may contain date information) by obtaining electrical signals every second from the divider circuit, and displays the time on the digital indicator 35.

The controller activates the altimeter in response to a command for activation of the altimeter by a predetermined user operation on the operation receiver 4, and obtains and stores in the memory a value of the altimeter at the time of activation as a reference altitude. Meanwhile, the controller drives the gears by the motor to rotate the pointer 33a around the pointer axis O2 and causes the pointer 33a to point at the position of “0” among the markers 33c. When the altitude obtained from the altimeter changes, the controller controls the motor according to the obtained altitude to rotate the pointer 33a and causes it to point at the marker 33c corresponding to the obtained altitude.

As explained hereinbefore, the altitude indicator 33 of the watch 1 includes the markers 33c, the pointer 33a that points at one of the markers 33c by rotating around the pointer axis O2. On the dial 30, the markers 33c adjacent to one another are labelled with the numerals 33d corresponding to the respective markers 33c, which allows the user to recognize the altitude easily, reducing misreading of the altitude.

It is thereby possible to realize an indicator of an altimeter with high user visibility on the dial 30 of the watch 1.

When the pointer 33a points at one of the markers 33c, the tip of the pointer 33a overlaps with that one of the markers 33c. This makes it possible for the user to easily recognize which one of the markers 33c the pointer 33a points at.

The pointer 33a does not overlap with the numerals 33d corresponding to the markers 33c. This can prevent the numerals 33d from being obscured by the pointer 33a.

The numerals 33d corresponding to the adjacent markers 33c are placed in a vertical array. This makes it possible to place the numerals 33d corresponding to the adjacent markers 33c in a limited space on the dial 30. It is also possible for the user to intuitively recognize whether the current altitude is lower or higher with respect to the reference altitude.

The markers 33c include a reference marker corresponding to a number that is a reference number, and the respective line segments of the markers 33c gradually get longer from the reference marker to the markers 33c placed further from the reference marker. Because of this, all the markers 33c can overlap with the tip of the pointer 33a and the correspondence between the numerals 33d and the markers 33c can be recognized easily. It is also possible for the user to intuitively recognize how much the current altitude has changed from the reference altitude.

The reference marker is placed at such a position that the pointer 33a is horizontal when the pointer 33a points at the reference marker. This makes it possible for the user to easily recognize whether the current altitude is lower or higher from the reference altitude.

The numerals 33d include 0 and other numerals denoting numbers with different signs, and pairs of numerals denoting numbers with different signs are placed symmetrically with respect to 0. This makes it possible for the user to easily recognize whether the current altitude is higher or lower than the reference altitude which is set as 0.

Each of plus and minus signs is placed in a display area different from a display area of the numerals 33d, and each sign is collectively attributed to the numerals 33d that are supposed to be with each sign. This makes it possible to display numerals with a sign even in a narrow and limited space on the dial 30.

The numerals and letters of the numerals 33d are colored differently from each other. This makes it possible for the user to recognize the altitude at a glance even when the numerals and letters are not visible.

The numeral 33d denoting 0 is placed at a position corresponding to the center of the hour marker 32 of the 9 o'clock or 3 o'clock in the direction of the array of the numerals 33d. It is thereby possible to keep the area for placing “+” and “−” of the sign display parts 33e. It is also possible to intuitively recognize plus/minus of the numerals 33d.

The description in the embodiments above is merely a suitable example of the watch 1 according to the present invention, and the present invention is not limited thereto.

For example, in the above embodiment, the display part 3 of the watch 1 to which the present invention is applied is analog-type, on which the time and altitude are indicated by rotation of the pointers 31 or the pointer 33a with rotation of the gears. However, the display part 3 of the watch 1 to which the present invention is applied may be fully composed of a liquid crystal display or an EL display and digitally indicates the time (cf. FIG. 1) or the altitude (cf. FIGS. 2 to 4). That is, the controller in the casing 2 may display, on the screen of the display part 3, the pointer axis O1, the pointers 31, the hour markers 32, and the graduations on the dial (shown in FIG. 1), the pointer axis O2, the pointer 33a, the reference point 33b, the markers 33c, the numerals 33d, the sign display parts 33e, and the like (shown in FIGS. 2 to 4), thereby indicating the time and the altitude.

In the above embodiment, the present invention is applied to the indicator of the altimeter mounted on the watch 1, but the present invention may be, for example, applied to an indicator of values obtained by other sensors which acquire predetermined information such as a barometric sensor, temperature sensor, humidity sensor, orientation sensor, and the like.

Further, in the above embodiment, the numerals 33d are placed in a vertical array as a preferable example, but the direction of the array of the numerals 33d is not limited.

In addition to the above, detailed configurations and detailed operation of the components of the watch 1 can also be appropriately modified without departing from the scope of the present invention.

Although the embodiments of the present disclosure have been described above, the technical scope of the invention is not limited to the embodiments described above, but is defined based on the scope of the claims. Furthermore, the technical scope of the present disclosure includes equivalents in which modifications that are not related to the essence of the present disclosure are added to the scope of the claims.

What is claimed is:

1. A watch comprising:
a dial on which a plurality of hour markers and a plurality of markers other than the plurality of hour markers are mounted;
a first pointer that points at one of the plurality of hour markers on the dial by rotating around a first rotation axis; and
a second pointer that points at one of the plurality of markers on the dial by rotating around a second rotation axis,
wherein numerals or letters respectively corresponding to the plurality of markers are placed on respective extension lines of the plurality of markers adjacent to one another,
wherein the letters include a set of letters.

2. The watch according to claim 1,
wherein, when the pointer points at one of the plurality of the markers, a tip of the pointer overlaps with the one of the plurality of the markers that is pointed at.

3. The watch according to claim 1,
wherein, when the pointer points at the one of the plurality of the markers, the tip of the pointer does not overlap with any one of the numerals or the letters that corresponds to the one of the plurality of the markers that is pointed at.

4. The watch according to claim 1,
wherein the numerals or the letters respectively corresponding to the plurality of markers adjacent to one another are placed in an array.

5. The watch according to claim 4,
wherein the plurality of markers include a reference marker that corresponds to a reference number,
wherein respective line segments of the plurality of markers get longer from the reference marker to ones of the plurality of markers that are placed further from the reference marker.

6. The watch according to claim 5,
wherein the reference marker is placed such that the pointer points at the reference marker in a horizontal direction.

7. The watch according to claim 5,
wherein the array in which the numerals or the letters are placed is perpendicular to an extension direction of the reference marker.

8. The watch according to claim 4,
wherein the numerals include 0 and other numerals with different signs, the other numerals being two sets of numerals denoting numbers respectively opposite of each other,
wherein the two sets of the numerals are placed symmetrically with respect to 0.

9. The watch according to claim 8,
wherein the signs are placed in respective display areas different from a display area of the numerals, and each of the signs is collectively given to each of the two sets of numerals denoting the numbers with the respective signs.

10. The watch according to claim 8,
wherein, being among the numerals or the letters in the array in a direction of an imaginary line connecting 12 o'clock and 6 o'clock, 0 is at a position corresponding to a center of one of the plurality of hour markers that indicates 9 o'clock or 3 o'clock.

11. The watch according to claim 1,
wherein the numerals or the letters are in different colors respectively.

12. The watch according to claim 1, comprising:
a sensor that obtains predetermined information,
wherein the markers indicate a value that is obtained from the sensor.

13. The watch according to claim 12,
wherein the sensor includes at least one of a barometric sensor, a temperature sensor, a humidity sensor, and an orientation sensor.

14. The watch according to claim 9,
wherein the signs include a plus sign and a minus sign,
wherein one of the plurality of hour markers is placed between a display area of the plus sign and a display area of the minus sign.
